(19) United States
(12) Patent Application Publication
(10) Pub. No.: US 2024/0298141 A1
(43) Pub. Date: Sep. 5, 2024

(54) SYSTEM AND METHODS FOR PAIRING AND CONFIGURING NETWORK DEVICES

(71) Applicant: Qorvo US, Inc., Greensboro, NC (US)

(72) Inventors: Shadi Hawawini, Mountain View, CA (US); Alexander Ivanov, Dublin (IE); Radhika Sanjeev Jagtap, The Hague (NL); Han Wesseling, Seoul (KR); Tim Allemeersch, Affligem (BE)

(21) Appl. No.: 18/584,406

(22) Filed: Feb. 22, 2024

Related U.S. Application Data
(60) Provisional application No. 63/578,334, filed on Aug. 23, 2023.
(60) Provisional application No. 63/488,282, filed on Mar. 3, 2023.

(51) Int. Cl. H04W 4/024; G06T 19/00; H04W 4/021

(52) U.S. Cl. CPC H04W 4/024; G06T 19/006; H04W 4/021

(57) ABSTRACT

A method for pairing an ultra-wideband (UWB) device in a local wireless network. The method includes obtaining device information of the UWB device; discovering, using the device information, the UWB device within a perimeter of the local wireless network; performing a UWB ranging operation with the UWB device to obtain position information of the UWB device; and displaying, on a user interface widget, an augmented reality (AR) indicator showing a location of the UWB device based on the position information of the UWB device.

### RELATED APPLICATIONS

This application claims priority to U.S. Provisional Patent Application No. 63/488,282 filed Mar. 3, 2023 and U.S. Provisional Patent Application No. 63/578,334 filed Aug. 23, 2023, which are incorporated by reference herein in their entireties.

### FIELD OF THE DISCLOSURE

The present disclosure relates to ultra-wideband-enabled devices and systems for facilitating pairing of network devices, in particular, to provide a more user-friendly way to visualize the devices to be paired using ultra-wideband (UWB) technology.

### BACKGROUND

The Internet of things (IoT) are objects with sensors, processing ability, software, and other technologies that connect and exchange data with other devices and systems over the Internet or other communication networks. IoT are widely used in home automation, e.g., in a smart home, which can include lighting, heating, air conditioning, media, security systems, and camera systems. In a smart home, IoT are paired to a local wireless network that covers the perimeter of the home space. A user can control and manage the IoT in the local wireless network from a mobile device. The user often need to manually add a new device into the local wireless network and configure it afterwards. For example, the wireless local network can be a wireless area network established based on network standards such as Matter, Zigbee, WiFi, IrDA, Thread, etc.

However, the existing pairing and configuring process can be cumbersome to a user. For example, a user may install multiple smart light bulbs (e.g., IoT) with a ladder, and attempts to pair and configure them after coming back to the ground level. When the light bulbs are powered on, it is difficult for the user to distinguish each light bulb from one another. Thus, a more user-friendly way to pair and configure a smart device is needed.

### SUMMARY

Embodiments of the disclosure provide a method for pairing/adding/commissioning an ultra-wideband (UWB) device in a local wireless network. The method includes obtaining device information of the UWB device;

discovering, using the device information, the UWB device within a perimeter of the local wireless network; performing a UWB ranging operation with the UWB device to obtain position information of the UWB device; and displaying, on a user interface widget, an augmented reality (AR) indicator showing a location of the UWB device based on the position information of the UWB device.

In some embodiments, the method further includes displaying, on the user interface widget, the UWB device. The UWB device is located in a field of view (FOV) of an imaging device communicatively coupled to the user interface widget; and the displaying of the AR indicator includes displaying a symbol overlaying with the UWB device.

In some embodiments, the UWB device is located outside a field of view (FOV) of an imaging device communicatively coupled to the user interface widget. The displaying of the AR indicator includes displaying, on the user interface widget, a symbol pointing to the location of the UWB device, and a notification message prompting a user to turn the image device towards the UWB device such that the UWB device is located in the FOV of the image device.

In some embodiments, the discovering of the UWB device includes establishing an out-of-band (OOB) channel with the UWB device prior to the UWB ranging operation; receiving a device identification (ID) of the UWB device through the OOB channel; and linking the device ID to the device information.

In some embodiments, the performing of the UWB ranging operation includes starting a UWB channel with the UWB device following the OOB channel; receiving the device ID and location data, from the UWB device in the UWB channel; computing the position information of the UWB device based on the location data; and linking the position information to the device ID.

In some embodiments, the method further includes displaying, on the user interface widget, the device information of the UWB device; displaying, on the user interface widget, a notification message prompting a user to select the UWB device to be paired with the local wireless network; and receiving, on the user interface widget, a user's selection of the symbol as a confirmation to pair the UWB device with the local wireless network.

In some embodiments, pairing the UWB device with the local wireless network includes transmitting device information to a network control device of the local wireless network, the network control device including, but not limited to, one or more of a hub, a router, a modem, a television, a set-top box, a smart speaker, a mobile device (e.g., tablet, mobile phone), or a range extender of the local wireless network.

In some embodiments, the OOB channel is a Bluetooth channel, and the device ID is a Bluetooth ID.

In some embodiments, computing the position information of the UWB device includes computing a distance to the UWB device and an angle-of-arrival of the UWB device.

In some embodiments, the local wireless network is a wireless area network established based on network standards of one or more of Matter, Zigbee, Bluetooth,

WiFi, IrDA, Thread, or a combination thereof; and the network control device is communicatively coupled to the Internet.

In some embodiments, the obtaining of the device information of the UWB device includes: receiving the device information through Bluetooth communication from the UWB device, near field communication (NFC) from the UWB device, UWB data communication, or scanning of a QR code of the UWB device; and storing the device information in a device database.

In some embodiments, the method further includes: gathering coordinates of the perimeter to generate a virtual map of the perimeter; computing coordinates of the UWB device based on the coordinates of the perimeter and the position information of the UWB device; and displaying, on the user interface widget, the virtual map and the UWB device based on the coordinates of the virtual map and the UWB device. The displaying of the AR indicator includes displaying the symbol overlaying with the UWB device in a sub-perimeter of the perimeter in the virtual map.

In some embodiments, the method further includes receiving coordinates of a second UWB device from the second UWB device; and determining if the UWB device and the second UWB device are in a same logical group based on the coordinates of the UWB device and the second UWB device.

In some embodiments, the method further includes, in response to the second UWB device being in the sub-perimeter, displaying, on the user interface widget, a notification message prompting a user to select the second UWB device to be paired to the UWB device such that the UWB device and the second UWB device are in the same logical group. The method may further include, in response to the second UWB device being beyond the sub-perimeter, displaying, on the user interface widget, a notification message prompting a user to select the second UWB device to be paired with a third UWB device in another sub-perimeter corresponding to the coordinates of the second UWB device.

In some embodiments, generating the virtual map of the perimeter includes one of employing artificial intelligent (AI) to generate the virtual map or utilizing the coordinates of the perimeter stored in a memory communicatively coupled to the user interface widget.

Embodiments of the present disclosure provide a method for pairing an ultra-wideband (UWB) device in a local wireless network. The method includes discovering a UWB device within a perimeter of the local wireless network; determining a relative position to the UWB device via UWB ranging; receiving coordinates of the UWB device from the UWB device; computing coordinates based on the coordinates of the UWB device and the relative position to the UWB device; and transmitting the coordinates.

In some embodiments, the determining of the relative position to the UWB device includes performing a UWB ranging operation with the UWB device to obtain a distance to the UWB device and an angle-of-arrival of the UWB device.

In some embodiments, the computing of the coordinate includes using at least one of two-way ranging, trilateration, triangulation, or multilateration on the coordinates of the UWB device and the relative position to the UWB device.

Embodiments of the present disclosure provide a UWB device. The UWB device includes a transceiver operable to perform a UWB communication; a memory for storing program instructions, device information, angle-of-arrivals and distances from the ranging operations; and a processor coupled to the transceiver and to the memory. The processor is operable to execute the program instructions, which, when executed by the processor, cause the UWB device to perform the following to pair another UWB device in a wireless local network: obtaining device information of the other UWB device; discovering, using the device information, the other UWB device within a perimeter of the local wireless network; performing a UWB ranging operation with the other UWB device to obtain position information of the UWB device; and displaying, on a user interface widget, an augmented reality (AR) indicator showing a location of the other UWB device based on the position information of the UWB device.

In some embodiments, the operations further include displaying, on the user interface widget, the other UWB device. The other UWB device is located in a field of view (FOV) of an imaging device communicatively coupled to the user interface widget; and the displaying of the AR indicator includes displaying a symbol overlaying with the other UWB device.

In some embodiments, the other UWB device is located outside a field of view (FOV) of an imaging device communicatively coupled to the user interface widget. The displaying of the AR indicator includes displaying, on the user interface widget, a symbol pointing to the location of the other UWB device, and a notification message prompting a user to turn the image device towards the other UWB device such that the other UWB device is located in the FOV of the image device.

In some embodiments, the discovering of the other UWB device includes: establishing an out-of-band (OOB) channel with the other UWB device prior to the ranging operation; receiving a device identification (ID) of the other UWB device through the OOB channel; and linking the device ID to the device information.

In some embodiments, the performing of the UWB ranging operation includes: starting a UWB channel with the UWB device following the OOB channel; receiving the device ID and location data, from the other UWB device in the UWB channel; computing the position information of the other UWB device based on the location data; and linking the position information to the device ID.

In some embodiments, UWB device further includes: displaying, on the user interface widget, the device information of the other UWB device; displaying, on the user interface widget, a notification message prompting a user to select the other UWB device to be paired with the local wireless network; and receiving, on the user interface widget, a user's selection of the symbol as a confirmation to pair the other UWB device with the local wireless network.

In some embodiments, pairing the other UWB device with the local wireless network includes transmitting device information to a network control device of the local wireless network, the network control device including, but not limited to, one or more of a hub, a router, a modem, a television, a set-top box, a smart speaker, a mobile device (e.g., tablet, mobile phone), or a range extender of the local wireless network.

In some embodiments, the OOB channel is a Bluetooth channel, and the device ID is a Bluetooth ID.

In some embodiments, computing the position information of the other UWB device includes computing a distance to the other UWB device and an angle-of-arrival of the other UWB device.

In some embodiments, the local wireless network is a wireless area network established based on network standards of one or more of Matter, Zigbee, Bluetooth, WiFi, IrDA, Thread, or a combination thereof; and the network control device is communicatively coupled to the Internet.

In some embodiments, the obtaining of the device information of the other UWB device includes: receiving the device information through Bluetooth communication from the other UWB device, near field communication (NFC) from the UWB device, UWB data communication, or scanning of a QR code of the UWB device; and storing the device information in a device database.

In some embodiments, the operations further include: gathering coordinates of the perimeter to generate a virtual map of the perimeter; computing coordinates of the UWB device based on the coordinates of the perimeter and the position information of the UWB device; and displaying, on the user interface widget, the virtual map and the UWB device based on the coordinates of the virtual map and the UWB device. The displaying of the AR indicator includes displaying the symbol overlaying with the UWB device in a sub-perimeter of the perimeter in the virtual map.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description, serve to explain the principles of the disclosure.

FIG. 1A illustrates exemplary wireless communication system that includes a wireless local network, a plurality of network devices in the wireless local network, and a mobile device communicatively coupled to the wireless local network, according to some aspects of the present disclosure.

FIG. 1B illustrates a block diagram of an exemplary mobile device configured for UWB communication, according to some aspects of the present disclosure.

FIG. 1C illustrates a block diagram of an exemplary network device configured for UWB communication, according to some aspects of the present disclosure.

FIG. 1D illustrates a signaling diagram between two UWB devices, according to some aspects of the present disclosure.

FIG. 1E illustrates another signaling diagram between two UWB devices, according to some aspects of the present disclosure.

FIG. 2A illustrates an example of pairing and configuring a network device using a mobile device, according to some aspects of the present disclosure.

FIGS. 2B-2H illustrate exemplary displays on a user interface (UI) widget for paring and configuring a network device, according to some aspects of the present disclosure.

FIGS. 3A-3D illustrate other exemplary displays on a UI widget for comparing and configuring a network device, according to some aspects of the present disclosure.

FIG. 4A illustrates an example of pairing and grouping network devices using a mobile device, according to some aspects of the present disclosure.

FIGS. 4B-4D illustrate other exemplary displays on a UI widget for pairing and grouping network devices using a mobile device, according to some aspects of the present disclosure.

FIG. 5A illustrates an exemplary method for a mobile device to facilitate pairing and configuring a network device using UWB ranging, according to some aspects of the present disclosure.

FIG. 5B illustrates an exemplary method for a network device to facilitate pairing and configuring a network device to a logical group of network devices, according to some aspects of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. Additionally, like reference numerals denote like features throughout specification and drawings.

It should be appreciated that the blocks in each signaling diagram or flowchart and combinations of the signaling diagrams or flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each signaling diagram or flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction for performing the functions described in connection with a block(s) in each signaling diagram or flowchart. Since the computer program instructions may be equipped in a computer or other programmable data processing devices, instructions that generate a process executed by a computer as a series of operational steps are performed by the computer or other programmable data processing devices and operate the computer or other programmable data processing devices may provide steps for executing the functions described in connection with a block(s) in each signaling diagram or flowchart.

Each block may represent a module, segment, or part of a code including one or more executable instructions for executing a specified logical function(s). Further, it should also be noted that in some replacement execution examples, the functions mentioned in the blocks may occur in different orders. For example, two blocks that are consecutively shown may be performed substantially simultaneously or in a reverse order depending on corresponding functions.

Hereinafter, embodiments are described in detail with reference to the accompanying drawings. Further, although a communication system using ultra-wideband (UWB) is described in connection with embodiments, as an example, the embodiments may also apply to other communication systems with similar technical background or features. For example, a communication system using Bluetooth or ZigBee may be included therein. Further, embodiments may be modified in such a range as not to significantly depart from the scope of the present disclosure under the determination by one of ordinary skill in the art and such modifications may be applicable to other communication systems.

UWB may refer to a short-range high-rate wireless communication technology using a wide frequency band of several hundreds of MHz to several GHz or more, low spectral density, and short pulse width (e.g., 1 nsec to 4 nsec) in a baseband state. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known, also referred to as anchor devices). The present disclosure assumes that the user is carrying a device capable of communicating through UWB (referred to as “UWB-enabled user device” or simply user device).

As previously described, in home automation, IoT are controlled and managed in a local wireless network, which is often a wireless area network. The local wireless network is established based on certain internet protocol(s) such as Matter, Zigbee, Bluetooth (BLE), WiFi, IrDA, etc. For example, Matter is an emerging application-layer connectivity standard designed to enable developers to increase the compatibility amongst the IoT in a local wireless network. Matter has an internet protocol (IP) based backhaul for interoperability and has defined BLE and/or near field communication (NFC) as a simple way to pair and provision devices.

There is some limitations in today's paring and configuring processes. For example, pairing using BLE and NFC can often be a good option if a user pairs only a single device, and that single device is nearby. However, it becomes cumbersome as the user pairs multiple devices, and the devices are not physically close. The existing pairing and configuring often include the following steps, e.g., 1) handling the to-be-paired device, 2) locating the QR code or NFC antenna location, 3) opening an application on a phone (in case of BLE), 4) scanning the QR code or tapping the NFC antenna location, 5) consenting to pairing the device onto the network, and 6) configuring the device in a group, scene or location. In a more specific example, a user may install multiple smart light bulbs with a latter or lift, then come back to the ground level to configure the devices. The challenge is that it can be very difficult to individually configure each device because the user likely cannot uniquely identify the light bulbs based on BLE, NFC, or QR code alone.

Embodiments of the present disclosure provide a system and methods that employ UWB-enabled devices to facilitate more accurate positioning and visualization of a network device in pairing and configuring the network device to the local wireless network. A user can use a mobile device to pair and configure a network device that has not been paired or configured before. The mobile device and the network device are each UWB-enabled, and can perform UWB ranging in between. The mobile device can accurately position the network device in a pairing process thanks to the UWB ranging, and indicate the position of the network device on a user interface (UI) widget using an augmented reality (AR) symbol. The mobile device can also link the network device to previously loaded device information, and present the device information to the user. The user can then select the desired network device by tapping the AR symbol. In some embodiments, the mobile device obtains relative position information such as an angle-of-arrival and a distance using UWB ranging. The pairing and configuring of a device using UWB ranging and AR can simplify the pairing and configuring processes, eliminating steps 1, 2, 4, and 5 in the existing pairing/configuring process.

In some embodiments, the network device can function as an anchor device in the local wireless network. The mobile device can generate a map of the perimeter covered by the local wireless network, and can configure the network device as an anchor in the map by generating absolute position information, e.g., coordinates, of the anchor device. The mobile device may send the absolute position information to the anchor device. When a new network device is installed, the new network device may range with the anchor device to obtain a relative position of the new network device to the anchor device and the absolute position information of the anchor device. The new network device may compute its absolute position information (e.g., coordinates) based on the relative position information and the absolute position information of the anchor device. The mobile device may receive the coordinates of the new network device and may generate logical grouping suggestions based on the absolute location of the new network device. For example, the mobile device may suggest the user to pair the new network device with a nearby network device (e.g., including the anchor device). Using UWB ranging in grouping the devices can thus eliminate step 6 in the existing pairing/configuring process.

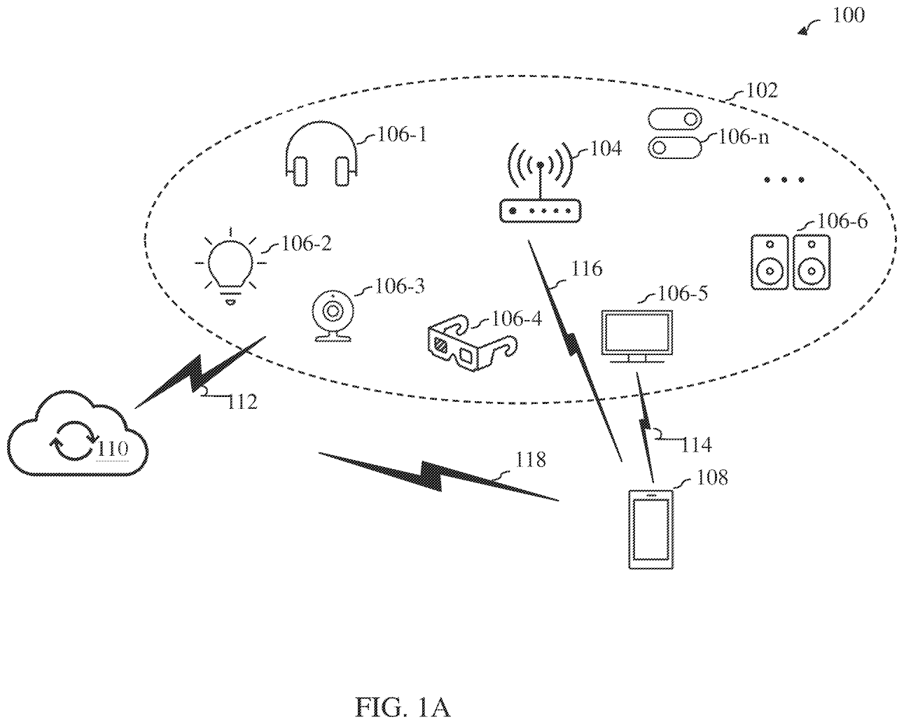

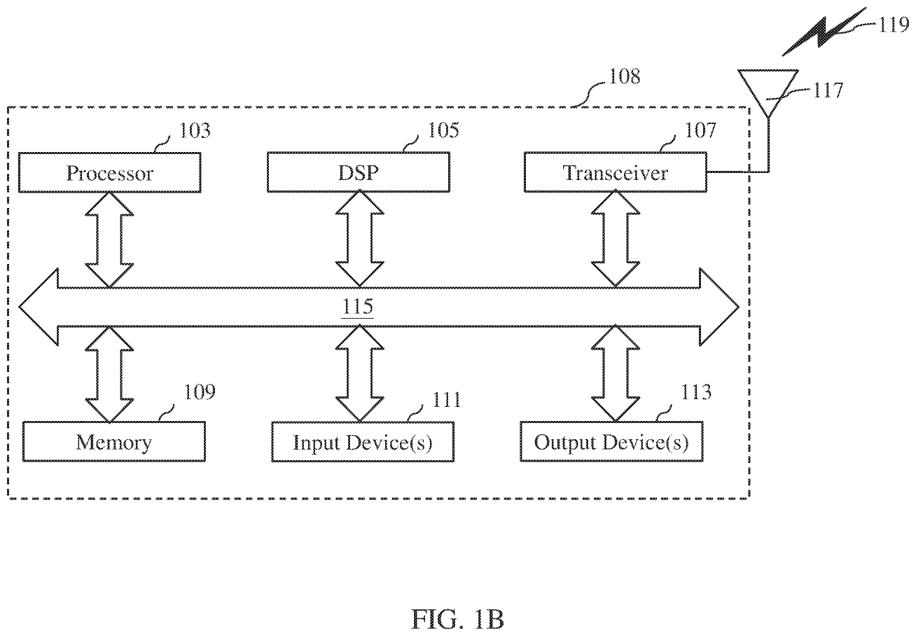

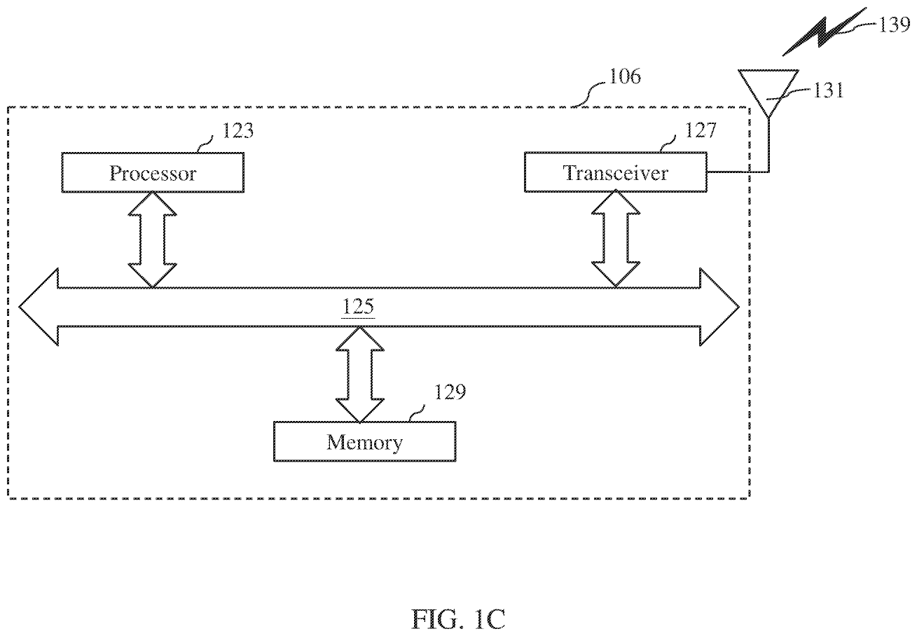

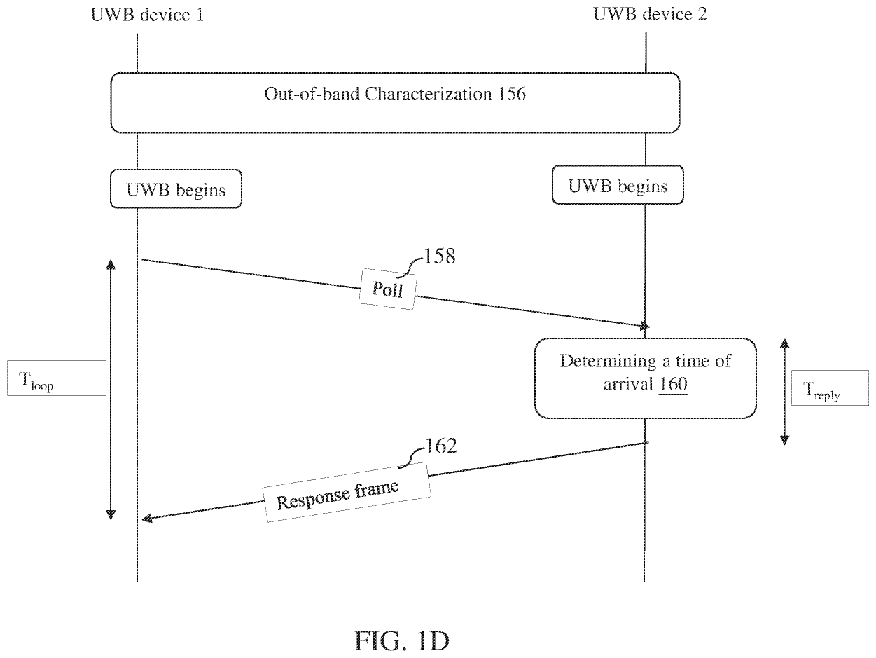

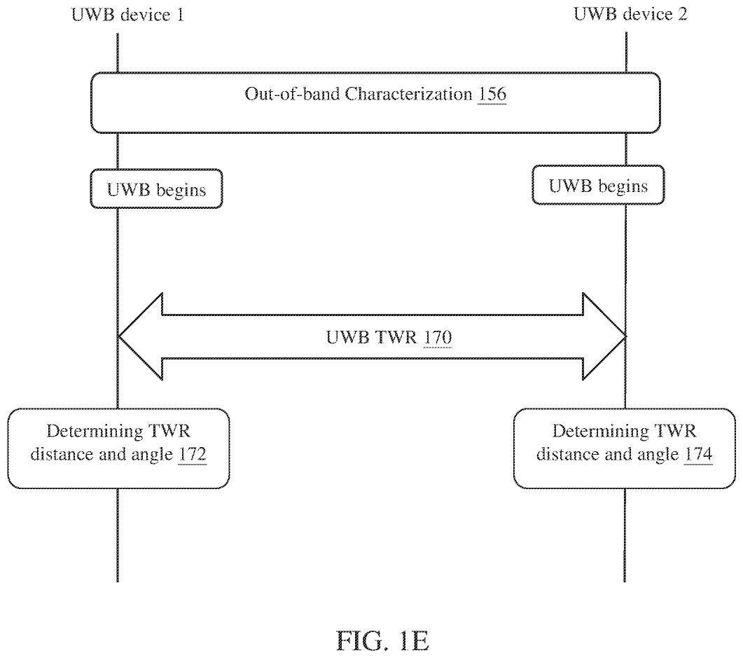

FIG. 1A is a diagram illustrating an example communication system 100 that includes a local wireless network, network devices in the local wireless network, and a mobile device communicatively coupled to the local wireless network, according to an example embodiment of the present disclosure.

Local wireless network 102 may include a network control device 104 and a plurality of network devices 106-1, 106-2, . . . , 106-n. Local wireless network 102 may be any wireless area network such as an automation network in a residential area, a hospital, a commercial building, a factory plant, a playground, a school, or the like. For ease of illustration, a home automation network is illustrated as examples in this disclosure. Network devices 106-1, . . . , 106-n may include a plurality of network devices that allow a user to access, control, and/or configure through mobile device 108. Mobile device 108 may be a “User Equipment” capable of voice and/or data communication. Mobile device 108 may have built-in software and hardware that enable mobile device 108 to communicate with network control device 104, network devices 106-1, . . . , 106-n, and/or cloud network 110 via radio signals. In some embodiments, mobile device 108 includes a UWB transceiver configured for ranging and/or data transfer. Mobile device 108 may include a cellular telephone, a smartphone, a laptop computer, a tablet, a personal digital assistant (PDA), a computing device, wearable devices (e.g., a smart watch, or the like), or any other mobile device having wireless connection capability. Although only a single mobile device 108 is shown in FIG. 1A, one of ordinary skill in the art will appreciate that multiple mobile devices may connect with the network devices 106-1, . . . , 106-n. A user may interact with network devices 106-1, . . . , 106-n using an application, a web browser, a proprietary program, or any other program executed and operated by the mobile device 108. In some embodiments, mobile device 108 may communicate directly with the network devices 106-1, . . . , 106-n (e.g., via communication link 114). In some embodiments, mobile device 108 may communicate with the network devices 106-1, . . . , 106-n via network control device 104 (e.g., via communication link 116) and/or the cloud network 110 (e.g., via communication link 118).

Network control device 104 has its radio communication range formed in a radio communication scheme. The communication range may cover a perimeter such as a house, a commercial building, a hospital, a playground, etc. For instance, network control device 104 may communicate data and signals with network devices 106-1, 106-2, . . . , 106-n located within the radio communication range as denoted by the dotted line using one or more radio communication schemes. Network control device 104 may also be communicatively connected to a cloud network 110 through wired/wireless communication link 112, and communicatively connected to a mobile device 108 through communication link 116. In some embodiments, network control device 104 may use a wired communication protocol and/or wireless communication protocols. Network control device 104 may acquire device information and device status information from network devices 106-1, . . . , 106-n located in the radio communication range and provide to cloud network 110 with the acquired information. Network control device 104 may also provide cloud network 110 with network control device information and network control device status information. In some embodiments, network control device 104 has wireless communication functions, and may include, but not limited to, one or more of a gateway, a hub, a television, a router, a modem, a range extender, a set-top box, a smart speaker, a mobile device (e.g., tablet, mobile phone), and/or the like. For example, network control device 104 may include a gateway that allows data to flow from local wireless network 102 to cloud network 110, or vice versa. In some embodiments, network control device 104 communicates using more than one internet protocol (IP) to connect local wireless network 102 and cloud network 110. In various embodiments, the network control device 104 communicates in IP's such as Matter, Zigbee, Bluetooth (BLE), WiFi, IrDA, etc.

Network devices 106-1, . . . , 106-n may transmit device information and device status information to network control device 104 and/or mobile device 108. Network devices 106-1, . . . , 106-n may each have built-in software and hardware that enable each network device to communicate with mobile device 108, and/or network control device 104 via radio signals such as UWB, WiFi, BLE, NFC, or the like. In some embodiments, each of network devices 106-1, . . . , 106-n includes a UWB transceiver configured for ranging and/or data transfer. For example, network devices 106-1, . . . , 106-n may include a headphone (e.g., 106-1), a light bulb (e.g., 106-2), a camera (e.g., 106-3), an augmented/virtual reality (AR/VR) device (e.g., 106-4), a television (e.g., 106-5), a speaker (e.g., 106-6), . . . , and a switch (e.g., 106-n).

Network control device 104 may also provide the mobile device 108 and the network devices 106-1, . . . , 106-n with access to one or more external networks, such as the cloud network 110, the Internet, and/or other wide area networks. Cloud network 110 may include a cloud infrastructure system that provides cloud services. In certain embodiments, services provided by cloud network 110 may include registration and access control of network devices 106-1, . . . , 106-n. Cloud network 110 may include one or more computers, servers, and/or systems. In some embodiments, cloud network 110 may include an application server that hosts an application, and a user may order and use the application via communication link 112. In some embodiments, wireless links 114 and 116 may each include a UWB communication interface. Wireless links 114 and 116 may also support other types of wireless connections, such as a Bluetooth communication interface, a Wi-Fi communication interface, a cellular network connection (e.g., 4G, 5G) interface, a near field communication (NFC) interface, a ZigBee communication interface, or a combination thereof.

Upon being powered on or reset, network devices 106-1, . . . , 106-n may be registered with the cloud network 110 and associated with a logical network within local wireless network 102. It should be appreciated that the local wireless network 102 may include other components than those depicted, and the specific number of components and/or their arrangement is not limited by the description of FIG. 1A.

FIG. 1B illustrates an example of mobile device 108. Mobile device 108 may be a cellular telephone, a smartphone, a laptop computer, a tablet, a personal digital assistant (PDA), a computing device, or any other mobile device having wireless connection capability. In some embodiments, mobile device 108 includes a processor 103, a digital signal processor (DSP) 105, a transceiver 107, an antenna 117, a memory 109, an input device 111, an output device 113, and a bus 115. The hardware components of mobile device 108 may be communicatively coupled to bus 115. In some embodiments, bus 115 can be used for processor 103 to communicate between cores and/or with memory 109. Processor 103 may include one or more general-purpose processors and/or one or more special-purpose processors (such as digital signal processing chips, graphics acceleration processors, and/or the like). Processor 103 may process wireless signals 119 received by transceiver 107, such as ranging signal/data from UWB communication. Input device 111 may include a camera, a mouse, a keyboard, a touch sensitive screen/display, a touch pad, a keypad, and/or the like. An output device 113 may include a display, a printer, and/or the like. In some embodiments, a user may load a pairing and configuring application, which automatically turns on the camera, which has a field of view (FOV). In some embodiments, a user may receive AR indicators on output device 113 (e.g., a user interface widget or a display), and may input a user's response to the AR indicator on input device 111 (e.g., the user interface widget or display).

Mobile device 108 may include a transceiver 107 communicatively coupled to bus 115. Transceiver 107 may be operable to transmit and receive wireless signals 119 via antenna 117. Wireless signals 119 may be transmitted/received via a wireless network. In some embodiments, the wireless network may be any wireless network such as a local wireless network (e.g., local wireless network 102), such as WiFi, a Personal Access Network (PAN), such as Matter, Bluetooth® or Zigbee®, or a cellular network (e.g., 4G, 5G). Transceiver 107 may be configured to receive signals 119 via antenna 117 from a network control device (e.g., 104), network devices (e.g., 106-1, . . . , 106-n), a cloud network (e.g., 110), and/or the like. Mobile device 108 may also be configured to decode and/or decrypt, via the DSP 105 and/or processor 103, various signals received from network control device 104, network devices 106-1, . . . , 106-n, cloud network 110, and/or the like.

Memory 109 may include one or more non-transitory storage devices that can include local and/or network accessible storage, a disk drive, a drive array, an optical storage device, a solid-state storage device such as a random access memory (“RAM”) and/or a read-only memory (“ROM”), a programmable ROM, a flash-updateable ROM, and/or the like. Such storage devices may be configured to implement any appropriate data storage, including without limitation, various file systems, database structures, and/or the like. In some embodiments, a device database, including device information (e.g., device identification (ID), device keys, vendor information, device type, etc.) of one or more of network devices 106-1, . . . , 106-n.

In various embodiments, functions/operations may be stored as one or more instructions or code in memory 109, such as on a computer-readable storage medium, such as RAM, ROM, FLASH, or disc drive, and executed by processor 103 or DSP 105. Mobile device 108 may also include software components (e.g., located within memory 109), including, for example, an operating system, device drivers, executable libraries, and/or other executable code, such as one or more application programs. The application programs may include computer programs, stored in memory 109, executed by processor 103 and/or DSP 105 to implement various functions under the control of the operating system. The computer programs may have been pre-packaged with mobile device 108 or may have been downloaded by a user into memory 109 of the mobile device 108. Some mobile applications may be more user-interactive applications, such as an application to pair and configure a network device and an AR application to indicate a location of a network device, whereas some other mobile applications may be less user-interactive in nature.

FIG. 1C illustrates an example of a network device 106, which may represent any one of network devices 106-1, . . . , 106-n. Network device 106 may include a transceiver 127 and an antenna 131 (communicatively coupled to transceiver 127) for wireless communication with mobile device 108 and/or network control device 104. Depending on the type, network device 106 may optionally include a processor 123, a memory 129, and a bus 125.

Transceiver 127 may be operable to transmit and receive wireless signals 139 via antenna 131. Wireless signals 139 may be transmitted/received via a wireless network. In some embodiments, the wireless network may be any wireless network such as a local wireless network (e.g., local wireless network 102), such as WiFi, a Personal Access Network (PAN), such as Matter, Bluetooth® or Zigbee®, or a cellular network (e.g., 4G, 5G). Transceiver 127 may be configured to wireless signals 139 via antenna 127 from a network control device (e.g., 104), a mobile device (e.g., 108), and/or the like. Optionally, network device 106 may include a DSP (not show) for decoding and/or decrypting, various received signals 139.

Optionally, network device 106 may include a processor 123 and a memory 129. Processor 123 may include one or more general-purpose processors and/or one or more special-purpose processors, similar to processor 103. Memory 129 may include one or more non-transitory storage devices, similar to memory 109. Optionally, network device 106 may include a bus 125 that communicatively couples processor 123, transceiver 127, and memory 129 such that processor 123 may execute instructions stored in memory 129 and may process signals 139 received by transceiver 127, such as ranging signal/data from UWB communication. In some embodiments, memory 129 may be stored with position information of one or more network devices. For example, memory 129 may be stored with relative position information of one or more other network devices, absolute position information for one or more network devices, etc.

A user may pair and configure network device 106 to local wireless network 102 through mobile device 108, using a paring and configuring application with AR features. The AR features may indicate the location of the network device that is computed based on UWB communication between network device 106 and mobile device 108. To pair and/or configure a network device, mobile device 108 and network device 106 may perform UWB communication to obtain position information of network device 106. FIG. 1D illustrates UWB communication between a UWB device 1 and a UWB device 2 using single-sided two-way ranging (SS TWR). In some embodiments, UWB device 1 may represent mobile device 108, and UWB device 2 may represent network device 106.

UWB device 1 may discover UWB device 2 using an out-of-band (OOB) technique, such as BLE, and may establish an OOB (e.g., BLE) channel for initial characterization 156 (e.g., negotiation and service data exchange). In some embodiments, UWB device 1 discovers UWB device 2 and establish the OOB channel using a device identification (ID) transmitted by UWB device 2 via BLE. After the initial characterization, UWB devices 1 and 2 may start UWB communications, e.g., a UWB ranging such as SS TWR. UWB device 1 may transmit a poll 158 to UWB device 2. UWB device 2 may determine a time of arrival 160 and transmit to UWB device 1 a response frame 162 after a time of reply T_{reply}. The response frame 162 may include information such as time of reply T_{reply} by UWB device 2. UWB device 1 may determine the time between the transmission of poll 158 and the receipt of response frame 162 to be Tₗₒₒₚ, and may compute a time of flight (TOF) to be (Tₗₒₒₚ−T_{reply})/2. UWB device 1 may compute a distance D between UWB device 1 and UWB device 2 to be D=TOF×speed of light. In some embodiments, UWB device 1 also determines an angle-of-arrival based on the phase change between poll 158 and response frame 162, detected from the antenna(s) of UWB device 1 (e.g., antenna 131). That is, UWB device 1 may determine a relative position of UWB device 2 (e.g., to UWB device 1) based on distance D and the angle-of-arrival. In some embodiments, response frame 162 also includes the device ID of UWB device 2.

In some embodiments, UWB device 1 represents mobile device 108 and UWB device 2 represents a second network device (e.g., an anchor device and/or another one of network devices 106-1, . . . , 106-n). UWB device 1 may range with UWB device 2, similar to the description above, to obtain a relative position of UWB device 2 (e.g., to UWB device 1). For example, UWB device 1 may compute the absolute location information (e.g., coordinates) of UWB device 2 based on the relative position information of UWB device 2 and absolute location information of the perimeter. UWB device 1 may further transmit the absolute location information of UWB device 2 to UWB device 2. The detail of the embodiment is described below.

In some embodiments, UWB device 1 represents a first network device (e.g., one of network devices 106-1, . . . , 106-n) and UWB device 2 represents a second network device (e.g., an anchor device and/or another one of network devices 106-1, . . . , 106-n). UWB device 1 may range with UWB device 2, similar to the description above, to obtain a relative position of UWB device 2 (e.g., to UWB device 1) and the absolute location information of UWB device 2. For example, UWB device 1 may determine a distance D and an angle-of-arrival from UWB device 2 to UWB device 1. In some embodiments, UWB device 1 may determine its own absolute location based on the relative location information of UWB device 2 and the absolute location of UWB device 2. The detail of the embodiment is described below.

FIG. 1E illustrates another UWB communication between a UWB device 1 and a UWB device 2 using double-sided two-way ranging (DS TWR). Different from the SS TWR shown in FIG. 1D, in some embodiments, UWB device 1 and UWB device 2 may perform DS TWR, e.g., UWB TWR 170 and respectively determining the TWR distance and—angle-of arrival in 172 and 174. It should also be noted that, other ranging methods may also be used to determine the distance and angle-of-arrival between UWB devices 1 and 2. The specific ranging method used between UWB devices 1 and 2 are not limited by the embodiments of the present disclosure.

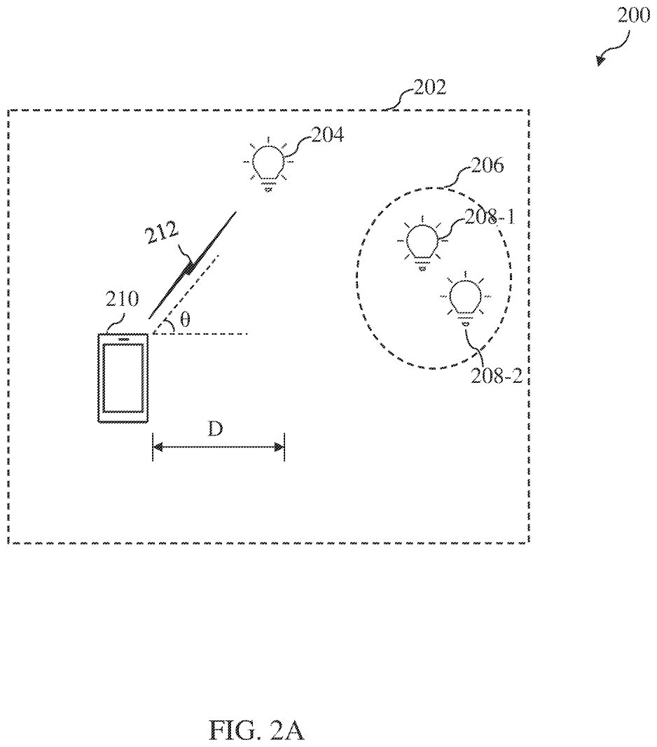

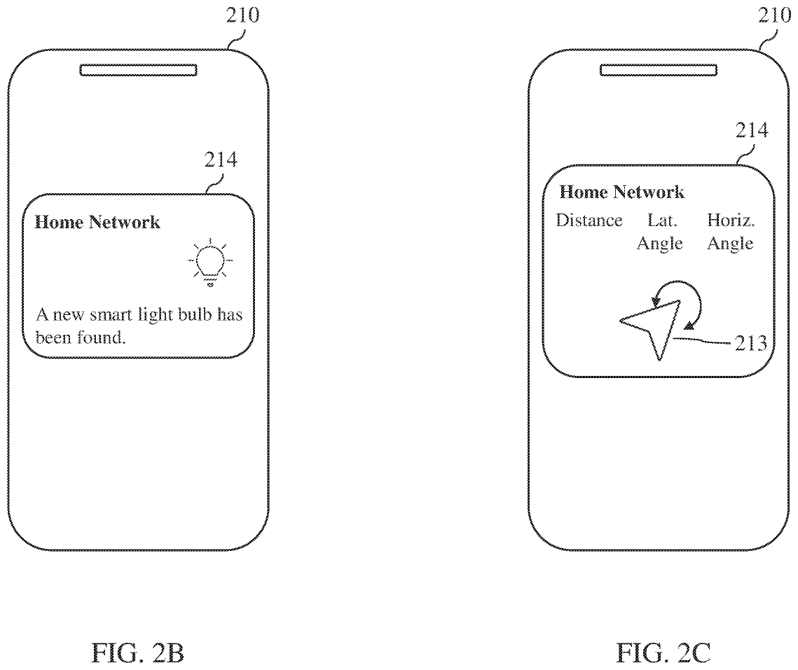

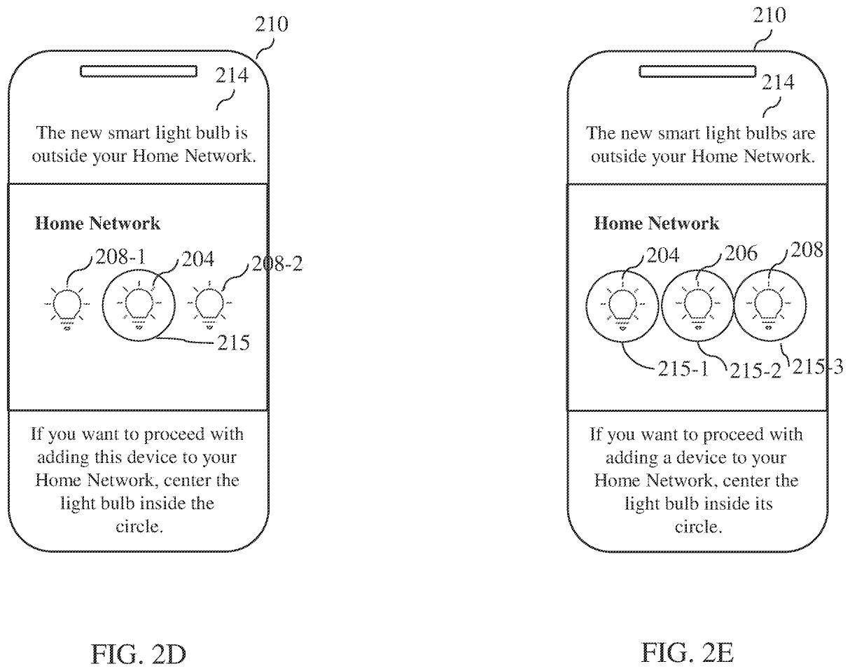

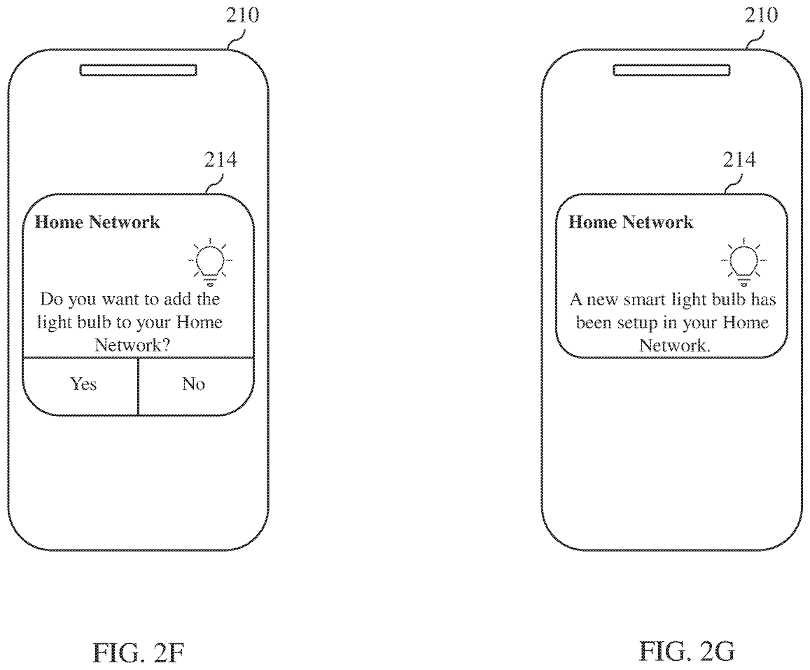

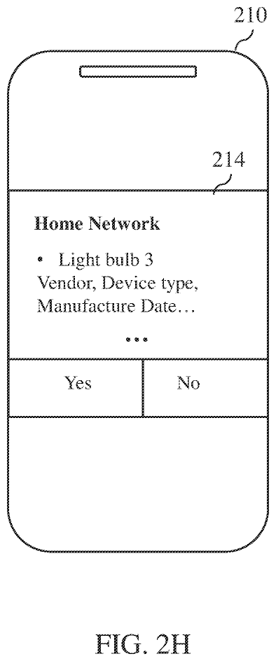

FIGS. 2A-2H illustrates a scenario 200 in which a user pairs and configures a newly installed network device 204 using a mobile device 210 enabled with UWB functions, according to embodiments of the present disclosure. Mobile device 210 may be an example of mobile device 108, such as a cellphone or a tablet. Network device 204 may be an example of a network device that has not been paired to a local wireless network 202 (e.g., similar to local wireless network 102). For ease of illustration, network device 204 is depicted as a light bulb. Network devices 208-1 and 208-2 may each represent any one of network devices 106-1, . . . , 106-n, that have been previously paired to and/or configured in local wireless network 202. Mobile device 210 and network device 204 may each be enabled of UWB functions and other non-UWB functions (e.g., OOB functions such as BLE, near field communication (NFC), WiFi, etc.). Mobile device 210 and network device 204 may communicate with each other via a wireless communication link 212, which may include various wireless communication means such as UWB communication, BLE communication, NFC communication, WiFi communication, etc.)

In an embodiment, network device 204 is not initially installed or paired to local wireless network 202. A user may load a pairing and configuring application (e.g., software), and add/import the device information of network device 204 into mobile device 210 prior to installation/pairing using the application. For example, the user may scan a QR code of network device 204, receive a NFC transmission from network device 204, receive a BLE transmission of network device 204, and/or receive other suitable OOB transmission. Mobile device 210 may thus receive the device information of network device 204 from one or more of the QR code, the NFC transmission, and the BLE transmission, UWB data communication, and may store the device information in a device database. The device information of network device 204 may include various types of data for pairing, configuring, and control of network device 204. In some embodiments, the device information includes a unique device ID (e.g., a OOB ID transmitted by network device 204 via non-UWB communication such as a BLE ID transmitted via BLE), device keys for pairing, vendor information, device type, and other manufacturer data. In some other embodiments, the device ID may also be any other types of unique ID's transmitted via non-UWB communication, such as a unique WiFi ID. The user may then install and/or power on network device 204 such that network device 204 may voluntarily transmit (e.g., “blink”) its device ID. In some embodiments, when multiple new network devices are installed, each one of these network devices may transmit its own unique device ID when powered on, while the user may import the device information of all the new network devices prior to installation.

The user may load the pairing and configuring application. Mobile device 210 may discover network device 204 using an OOB means (e.g., BLE) and establish an OOB channel (e.g., a BLE channel) with network device 204 using unique device ID “blinked” by network device 204, and start ranging with network device 204 using UWB, referring back to the description of FIGS. 1D and 1E. Mobile device 210 may compute, based on the response frame received in UWB ranging (e.g., via wireless communication link 212), relative position information of network device 204. In some embodiments, the relative position information includes a distance D and an angle-of-arrival θ from network device 204 to mobile device 210. In some embodiments, mobile device 210 also receives the device ID through the data transfer of the UWB communication.

Mobile device 210 may determine a relative position/position of network device 204 based on the relative position information, and may display on a screen/display (e.g., a user interface widget) an AR indicator showing the location/position of network device 204 using the computed relative position information. The screen may be touch sensitive, and may receive the user's input via touch. In some embodiments, network device 204 is located in a field of view (FOV) of an imaging device (e.g., a camera) of mobile device 210 such that mobile device 210 displays network device 204 and the AR indicator, while the AR indicator includes a symbol that overlays with network device 204. In some embodiments, network device 204 is located outside the FOV of the image device such that the mobile device 210 does not display network device 204, and the AR indicator includes a symbol that points to the location of network device 204. In this case, the user may move mobile device 210 towards network device 204 until network device 204 is located in the FOV of the imaging device and the AR indicator is shown to overlay with network device 204. The user may select network device 204 by tapping on the AR indicator.

After receiving the user's selection, mobile device 210 may search for network device 210 in the device database based on the device ID received/detected prior to the UWB ranging (e.g., in the OOB channel configuration step) and/or received in the data transfer of the UWB ranging. Mobile device 210 may link/map the received/detected device ID with the device ID previously stored in the device database. When mobile device 210 determines a match, mobile device 210 may prompt the user to pair network device 204 to local wireless network 202 on the screen. A user may confirm selection by tapping the screen. In some embodiments, mobile device 210 may also display the device information linked to the device ID (e.g., stored in the device database) on the screen for the user to confirm. After receiving the user's confirmation, mobile device 210 may start facilitating the pairing of network device 204 to local wireless network 102, e.g., by setting up a secure OOB link (e.g., BLE communication link) with network device 204 and transmitting the device information of network device 204 (e.g., device keys, etc.) to network control device 104 for validation, etc.

FIGS. 2B-2H illustrate screen displays in scenario 200, according to some embodiments. When mobile device 210 discovers network device 204 and locate the received/detected device ID in the device database, mobile device 210 may display a notification of “a smart light bulb has been found” and a symbol (e.g., an AR symbol) of the network device 204 on screen 214. Mobile device 210 may range with network device 204 to determine a relative position of network device 204 based on the UWB ranging. Based on the position of network device 204 and the ranging result, mobile device 210 may display different AR indicators on screen 214. FIG. 2C illustrates the display of mobile device 210 when network device 204 is out of FOV of the imaging device (e.g., camera) of mobile device 210. In some embodiments, mobile device 210 shows the relative position of network device 204 by showing the “Distance,” “Lat Angle (or lateral angle),” “Horiz Angle (or horizontal angle),” and an AR indicator 213 of an arrow. The arrow may point to network device 204 in real-time based on the relative position information computed from the UWB ranging. A user may move mobile device 210 accordingly such that the lateral angle and the horizontal angle both decrease, and network device 204 is located in the FOV of mobile device. Mobile device 210 may then show network device 204 and an AR indicator 215 that overlays with network device 204, as shown in FIGS. 2D and 2E. Mobile device 210 may also display notifications to prompt the user to pair network device 204 to local wireless network 102. For example, mobile device 210 may display a notification of “The new smart light bulb is outside your Home Network,” in which the Home Network refers to local wireless network device 102. Mobile device 210 may also display instructions for the user to pair network device 204 “If you want to proceed with adding this device to your Home Network, center the light bulb inside the circle.” In some embodiments, mobile device 210 display all network devices in the FOV (e.g., including those that are already paired to local wireless network 102), but only shows AR indicator 215 overlaying with one network device 204 that has not been paired to local wireless network 102.

In some embodiments, as shown in FIG. 2E, mobile device 210 may display more than one (e.g., all) network devices that are not paired to local wireless network 102. For example, mobile device 210 may display AR indicators 215-1, 215-2, and 215-3 respectively overlaying with network devices 204, 206, and 208 that are not previously paired to local wireless network 102. Mobile device 210 may or may not display any paired network devices in the FOV of the imaging device. The user may select the desired network device by tapping on screen 214. In some embodiments, although not shown, mobile device 210 displays only the network devices in the FOV of the imaging device and are not previously paired to local wireless network 102, but not the network devices that are paired and in the FOV of the imaging device.

After receiving the user's selection, mobile device 210 may prompt the user to confirm selection on screen 214, as shown in FIG. 2F. After receiving the user's confirmation (e.g., tap on the “Yes” option), mobile device 210 may start facilitating the pairing of network device 204 to local wireless network 102, and notifies the user when the pairing is completed, as shown in FIG. 2G. In some embodiments, as shown in FIG. 2H, mobile device 210 may display device information upon the user's selection, e.g., in FIG. 2D or 2E, prior to the prompting in FIG. 2F. The user may confirm selection by tapping the “Yes” option on screen 214 or reject selection by tapping the “No” option. The configuration of network device 204 is completed.

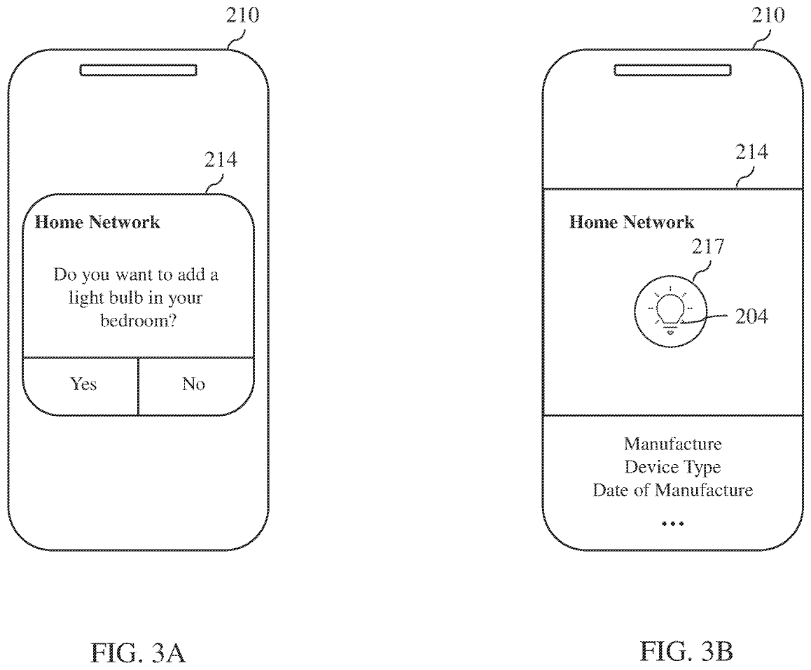

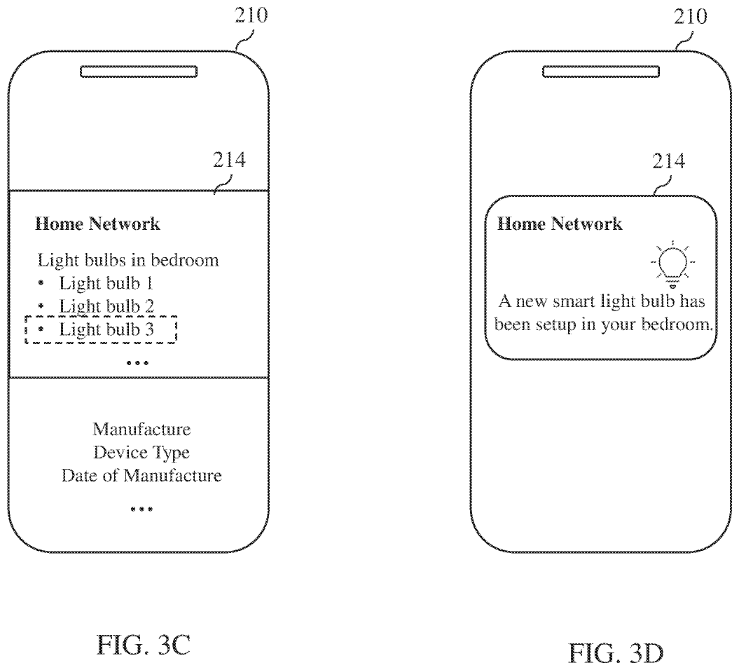

FIGS. 2A, and 3A-3D illustrate a scenario in which a network device 204 installed but not configured is added to a logical group 206 of network devices that are already paired to local wireless network 202. Mobile device 210 may make logical suggestions based on the positions of network device 204 and logical group 206. Network devices 208-1 and 208-2 may represent one or more of network devices 206-1, . . . , 206-n that have previously been paired to local wireless network 202 and configured. In some embodiments, network devices 208-1 and 208-2 may be in logical group 206 such that they can be controlled together. Logical group 206 may be located in a sub-perimeter of the perimeter covered by local wireless network 202. For example, network devices 208-1 and 208-2 may be located sufficiently close to each other, e.g., two light bulbs installed in the same room and can be controlled via a single switch. Network device 204 may be installed in the same room but not configured. In various embodiments, network device 204 may or may not been previously paired to local wireless network 202. In some embodiments, mobile device 210 may be stored with a device database with the device information (e.g., unique device ID, device keys, vendor information, etc.) of all installed network devices, including network devices 204, 208-1, and 208-2. In some embodiments, mobile device 210 imported the device information previously received via one or more of a QR code, NFC transmission, BLE transmission, UWB data communication, and any other suitable OOB transmission.

The user may load the pairing and configuring application to start adding a new network device. Mobile device 210 may discover network device 204 using an OOB means, and may start UWB ranging with network device 204. Based on the unique device ID detected in the OOB characterization and/or received in the UWB ranging, mobile device 210 may locate the matching device information of network device 204 in the device database. Using the relative position information obtained from the UWB ranging, mobile device 210 may display an AR symbol that overlays with network device 204 or points to the location of network device 204. After receiving the user's selection of network device 204 (e.g., by tapping on the AR symbol), mobile device 210 may display the device information for the user to confirm. After receiving the user's confirmation, mobile device 210 may link network device 204 to the device information in the device database. The configuration of network device 204 is then completed. Mobile device 210 may stop UWB ranging (e.g., distance measurement and angle-of-arrival computation) until the user starts a new configuration phase again. Detailed description of similar operation may be referred to that of FIGS. 2B-2H, and is not repeated herein.

In some embodiments, when the user loads the pairing and configuring application, mobile device 210 also detects nearby network devices that have been paired and configured (e.g., network devices 208-1 and 208-2), e.g., through OOB means. Mobile device 210 may start ranging with network devices 208-1 and 208-2 to determine relative position information such as distances and/or angle-of-arrivals from them. Based on the relative position information to these paired/configured network devices, mobile device 210 may determine user (e.g., holding mobile device 210) is in the proximity of logical group 206 (e.g., or the sub-perimeter such as a bedroom). Mobile device 210 may then make logical suggestions by prompting the user to add the newly configured network device 204 to logical group 206 such that network devices 204, 208-1, and 208-2 may be controlled together.

For example, when the user loads the pairing and configuring application, mobile device 210 may start the OOB configuration to detect nearby network devices (e.g., unpaired, paired, not configured, and/or configured). Mobile device 210 may determine the user is in the proximity of logical group 206 by ranging with network devices 204, 208-1, and 208-2, and may display a notification prompting the user to add network device 204 to logical group 206 (e.g., the sub-perimeter such as a bedroom). As shown in FIG. 3A, mobile device 210 may display a notification of “Do you want to add a light bulb in your bedroom?” The user may confirm by tapping on the “Yes” option. After receiving the user's selection, mobile device 210 may display an AR indicator 217 overlaying with network device 204 in the FOV, and device information of network device 204. In some embodiments, alternatively or additionally to FIG. 3B, mobile device 210 presents on screen 214 all the network devices in logical group 206 (e.g., the sub-perimeter or bedroom) while highlighting the newly added network device 204 (shown as “Light bulb 3”), as shown in FIG. 3C, after the user makes a selection/confirmation in FIG. 3A. Mobile device 210 may also display the device information, collected from the device database, on screen 214 while highlighting network device 204. In some embodiments, as shown in FIG. 3D, mobile device 210 shows, on screen 214, the confirmation of adding/pairing network device 204 to logical group 206 by showing the adding of network device 204 to the sub-perimeter, e.g., “A new smart light bulb has been setup in your bedroom.”

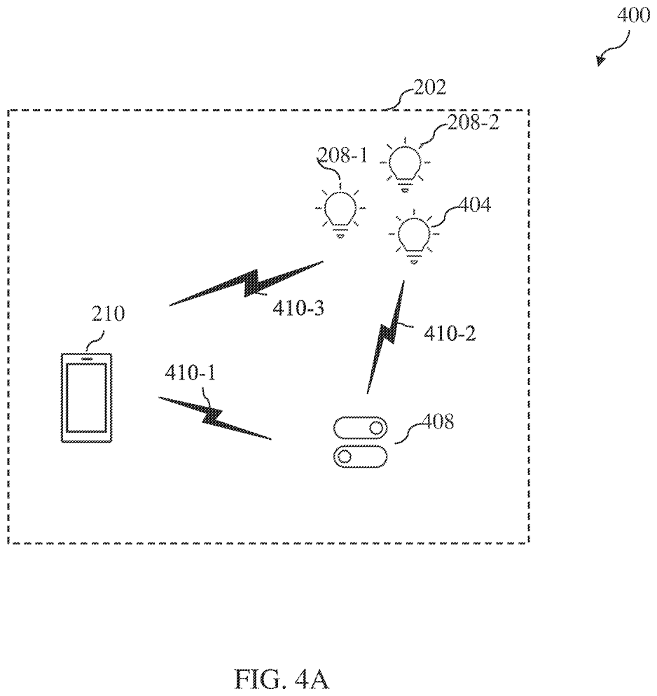

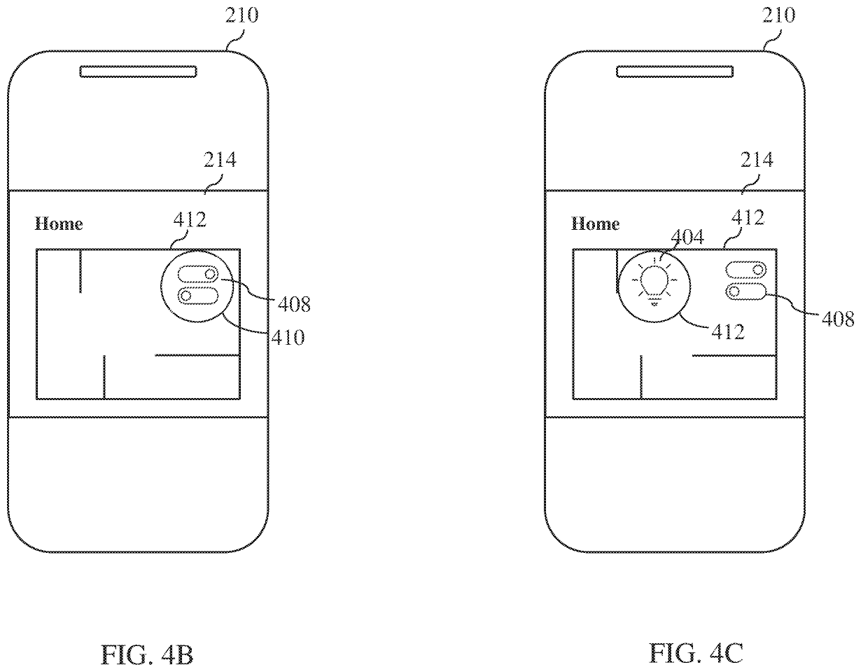

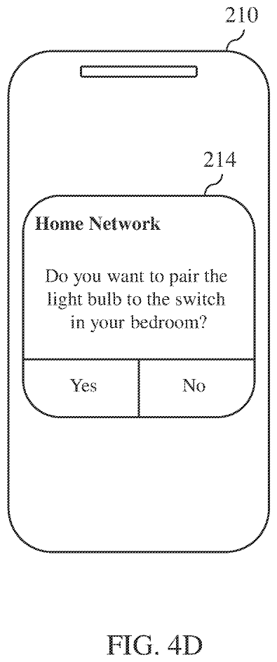

FIGS. 4A-4D illustrate a scenario 400 in which a newly added network device (e.g., 404) positions itself using UWB ranging, and mobile device 210 makes logical suggestions based on the position information of the newly added network device and the position information of the network devices that are previously paired and configured (e.g., 208-1, 208-2, and/or 408). In some embodiments, scenario 400 may be an example of real-time location service that shows the location of a network device (e.g., a tag) in real-time. Network devices 208-1, 208-2, 404, and 408 may each be any one of network devices 106-1, . . . , 106-n, and may each be UWB-enabled. In some embodiments, network devices 208-1, 208-2, and 408 may be in a logical group because of geographical proximity, e.g., in the same room or close to each other. For ease of illustration, network devices 208-1, 208-2, and 404 are depicted as light bulbs, and network device 408 is depicted as a switch. Communication links 410-1 (between mobile device 210 and network device 408), 410-2 (between network device 408 and network device 404), and 410-3 (between network device 404 and mobile device 210) may each facilitate UWB communication and one or more OOB communication means such as BLE, WiFi, NFC, etc.

Mobile device 210 may generate a virtual map of the perimeter covered by local wireless network 202. Mobile device 210 may gather absolute position information such as coordinates of the rooms, and use artificial intelligence (AI) to generate the virtual map. The absolute position information may be imported from another application (e.g., other than the pairing and configuring application), prestored in the memory, downloaded from the Internet, transmitted from another wireless device, or collected in any suitable ways. Mobile 210 may also use AR to display the virtual map when the user loads the pairing and configuring application. Network device 408 may be installed using the paring and configuring application. Using communication link 410-1, the user may pair and configure network device 408 using the paring and configuring application, similar to the description in FIGS. 2A-2H. After network device 408 is paired and configured, mobile device 210 may compute absolute position information (e.g., coordinates) of network device 408 based on its location in the virtual map and the absolute position information (e.g., the coordinates) of the virtual map (or the perimeter covered by local wireless network 202). For example, the location of network device 408 may be computed based on the location of mobile device 210 and the relative position of network device 404 from mobile device 210. In some embodiments, coordinates of network device 408 are generated by mobile device 210. Mobile device 210 may transmit the absolute position information to network device 408, which stores its absolute position information in its memory. In various embodiments, mobile device 210 transmits the absolute position information via any suitable communication means such as BLE, WiFi, UWB, NFC, etc. Network device 408 may then function as an anchor device in local wireless network 202.

After the installation, pairing, and configuration of network device 408, the user may install network device 404, which may function as a tag in local wireless network 202. Installed, network device 404 may discover and range with network device 408 (e.g., an anchor) to locate its location/position (e.g., distance and angle-of-arrival) relative to network device 404. In some embodiments, network device 404 range with more than one anchor devices (not shown) to obtain relative position (e.g., distance and angle-of-arrival) to each anchor device. Meanwhile, via communication link 410-2, network device 408 (and any other anchor devices that range with network device 404) may transmit, using one or more of BLE, WiFi, UWB, NFC, etc., to network device 404 the absolute position information (e.g., coordinates) of network device 408 (and each anchor device). Network device 404 may compute its absolute position information, e.g., coordinates, based on the relative position information to each anchor device and the absolute position information of each anchor device. In some embodiments, the computation includes one or more of TWR, trilateration, triangulation, multilateration, or the like.

Mobile device 210 may discover network device 404. The device information of network device 404 may be imported by mobile device 210, and mobile device 210 may locate network device 404 using UWB ranging, as described in FIGS. 2A-2H. Mobile device 210 may employ AR to display the virtual map and network device 404 in the virtual map based on its relative position to mobile device 210. Network device 404 may transmit to mobile device 210, via one or more of BLE, WiFi, UWB, NFC, etc., the absolute position information (e.g., coordinates) of network device 404. Mobile device 210 may then determine which network devices can be in the same logical group based on the absolute position information of various network devices, and make logical suggestions to the user. For example, mobile device 210 may determine network devices 208-1, 208-2, 404, and 408 may be in the same room based on the absolute locations of each of the network devices, and may suggest the user to pair network device 404 with network device 408 and/or network devices 208-1 and 208-2.

For example, as shown in FIG. 4B, mobile device 210 may generate a virtual map 412 using AI, and may display virtual map 412 on screen 214 using AR. Virtual map 412 may show the floor plan of a portion or the entirety of the perimeter of local wireless network 202. The user may load the pairing and configuring application which automatically loads virtual map 412. In various embodiments, mobile device 210 displays virtual map 412 while showing network device 408 and an AR indicator 410 that overlays with network device 408 for pairing. In some embodiments, mobile device 210 runs virtual map 412 in the backstage and does not show it on screen 214. The user may pair and configure network device 408, using the process similar to that described in FIGS. 2A-2H.

After the user installs network device 404, mobile device 210 may show network device 404 and an AR indicator 412 overlaying with network device 404 on screen 214, as shown in FIG. 4C. Mobile device 210 may prompt the user to pair network device 404 to local wireless network 412 as described before. In some embodiments, mobile device 210 determines network devices 404 and 408 are in the same room based on their absolute position information (e.g., coordinates), and suggests to the user to pair the network device 404 (e.g., a newly installed light bulb in the bedroom) with network device 408 (e.g., a switch in the bedroom), as shown in FIG. 4D. The user may confirm the pairing such that network devices 404 and 408 are in the same logical group, and can be controlled together.

In some embodiments, scenario 400 can be used in a real-time location service. As described above, using UWB ranging, a network device (e.g., a tag) may compute and transmit its own absolute location information (e.g., coordinates) in real-time, so mobile device 210 may display the network device in the virtual map based on its real-time absolute location information.

It should be noted that, the network devices illustrated in this disclosure are merely illustrative examples, and should not limit the scope of the present disclosure. For example, a network device newly installed in a sub-perimeter may be paired with an anchor device in the sub-perimeter. The network device and the anchor may each include any one of network devices 106-1, . . . , 106-n.

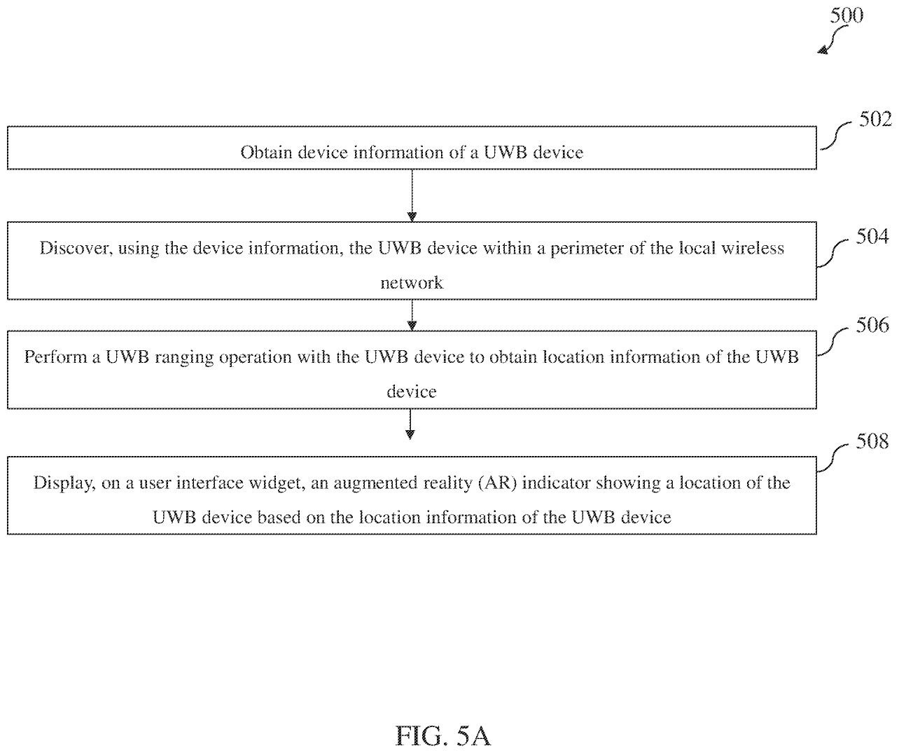

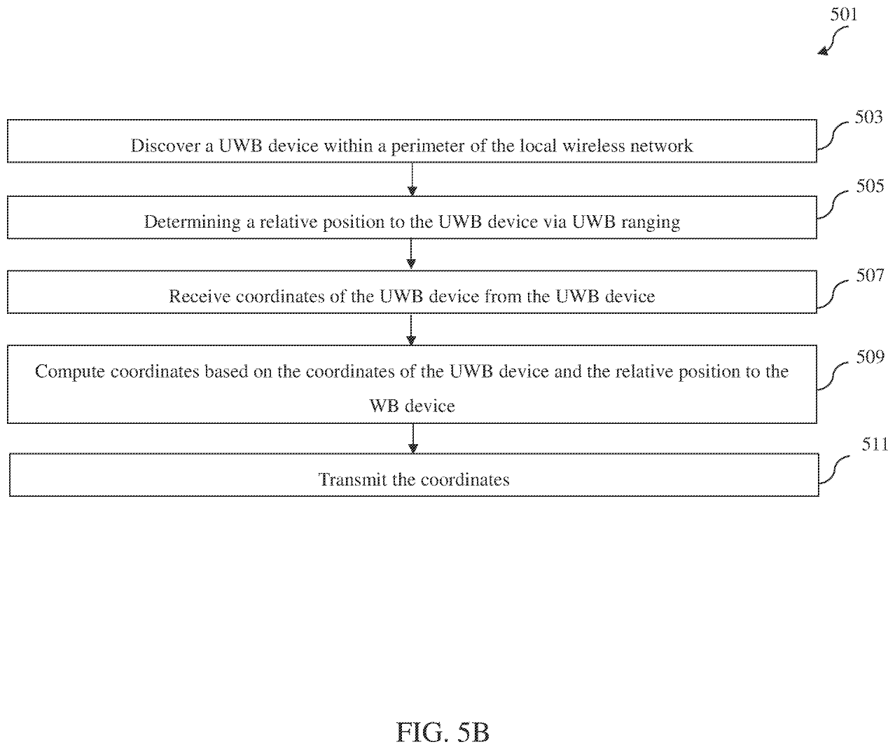

FIG. 5A is a flowchart of a method 500 for a mobile device to facilitate seamless pairing and configuring a UWB device, according to some embodiments of the present disclosure. Method 500 is merely an example, and is not intended to limit the present disclosure beyond what is explicitly recited in the claims. Additional operations can be provided before, during, and after the method 500, and some operations described can be replaced, eliminated, or moved around for additional embodiments of method 500. For ease of illustration, FIG. 5A is described in connection with FIGS. 1D, 1E, 2A-2E, 3B, and 4A-4C.

At step 502, device information of a UWB device is obtained. Referring back to the description of FIGS. 2A, 3B, and 4A, mobile device 210 may import device information of UWB device 204 or 408 by scanning a QR code, NFC transmission, BLE transmission, UWB data communication, or other OOB transmission.

At step 504, device information is used to discover the UWB device within a perimeter of the local wireless network. Referring back to the description of FIGS. 2A, 3B, and 4A, mobile device 210 may discover network device 204 or 408 by detecting a unique OOB device ID (e.g., a BLE device ID) and start OOB characterization with network device 204 or 408.

At step 506, a UWB ranging operation is performed with the UWB device to obtain position information of the UWB device. Referring back to the description of FIGS. 1D, 1E, 2A, 3B, and 4A, mobile device 210 (i.e., UWB device 1 in FIGS. 1D and 1E) may establish a UWB channel with network device 204 or 408 (i.e., UWB device 2 in FIGS. 1D and 1E) following the OOB characterization, and may perform a UWB ranging (e.g., TWR) with network device 204 or 408, to obtain relative position information of the network device. The relative position information includes a distance and an angle-of-arrival to mobile device 210.

At step 508, an AR indicator showing a location of the UWB device based on the position information of the UWB device displaying, is displayed on a user interface widget. Referring back to the description of FIGS. 2C-2E, 3B, and 4B, based on the relative position information of network device 204 or 408, mobile device 210 may compute and display an AR indicator (e.g., 213, 215, 215-1, 215-2, 215-3, 217, or 410) showing the location of the network device on a screen. In some embodiments, the AR indicator includes a symbol pointing to the network device when the network device is out of the FOV of mobile device 210, or a symbol overlaying with the network device when the network device is in the FOV of mobile device 210.

FIG. 5B is a flowchart of a method 501 for a network device to facilitate seamless pairing and configuring to a logical group of network devices, according to some embodiments of the present disclosure. Method 501 is merely an example, and is not intended to limit the present disclosure beyond what is explicitly recited in the claims. Additional operations can be provided before, during, and after the method 501, and some operations described can be replaced, eliminated, or moved around for additional embodiments of method 501. For ease of illustration, FIG. 5B is described in connection with FIGS. 1D, 1E, and 4A-4D.

At step 503, a UWB device is discovered within a perimeter of the local wireless network. Referring back to the description of FIG. 4A, a network device 404 discovers another network device 408 (e.g., an anchor device) in the perimeter of the local wireless network (e.g., local wireless network 202) via OOB configurations.

At step 505, a relative position to the UWB device is determined via UWB ranging. Referring back to the description of FIGS. 1D, 1E, and 4A, network device 404 may determine a relative position of network device 408 (i.e., to network device 404) by using UWB ranging. In some embodiments, the relative position includes a distance and an angle-of-arrival from network device 408 to network device 404.

At step 507, coordinates of the UWB device is received from the UWB device. Referring back to the description of FIG. 4A, network device 404 receives the coordinates of network device 408 via transmission such as UWB, BLE, WiFi, NFC, etc.

At step 509, coordinates are computed based on the coordinates of the UWB device and the relative position to the WB device. Referring back to the description of FIG. 4A, network device 404 may compute its coordinates based on the coordinates of network device 408 and the relative position information from network device 408 and network device 404.

At step 511, the coordinates are transmitted. Referring back to the description of FIGS. 4A-4D, network device 404 may transmit its coordinates to mobile device 210 such that mobile device 210 may make logical suggestions based on the coordinates of network devices 404, 408, and/or others in the perimeter of local wireless network 202.

Those skilled in the art will recognize improvements and modifications to the preferred embodiments of the present disclosure. All such improvements and modifications are considered within the scope of the concepts disclosed herein and the claims that follow.

What is claimed is:

1. A method for pairing an ultra-wideband (UWB) device in a local wireless network, comprising:
obtaining device information of the UWB device;
discovering, using the device information, the UWB device within a perimeter of the local wireless network;
performing a UWB ranging operation with the UWB device to obtain position information of the UWB device; and
displaying, on a user interface widget, an augmented reality (AR) indicator showing a location of the UWB device based on the position information of the UWB device.

2. The method of claim 1, further comprising displaying, on the user interface widget, the UWB device, wherein:
the UWB device is located in a field of view (FOV) of an imaging device communicatively coupled to the user interface widget; and
the displaying of the AR indicator comprises displaying a symbol overlaying with the UWB device.

3. The method of claim 1, wherein:
the UWB device is located outside a field of view (FOV) of an imaging device communicatively coupled to the user interface widget; and
the displaying of the AR indicator comprises displaying, on the user interface widget,
a symbol pointing to the location of the UWB device, and
a notification message prompting a user to turn the image device towards the UWB device such that the UWB device is located in the FOV of the image device.

4. The method of claim 1, wherein the discovering of the UWB device comprises:
establishing an out-of-band (OOB) channel with the UWB device prior to the UWB ranging operation;
receiving a device identification (ID) of the UWB device through the OOB channel; and
linking the device ID to the device information.

5. The method of claim 4, wherein the performing of the UWB ranging operation comprises:
starting a UWB channel with the UWB device following the OOB channel;
receiving the device ID and location data, from the UWB device in the UWB channel;
computing the position information of the UWB device based on the location data; and
linking the position information to the device ID.

6. The method of claim 2, further comprising:
displaying, on the user interface widget, the device information of the UWB device;
displaying, on the user interface widget, a notification message prompting a user to select the UWB device to be paired with the local wireless network; and
receiving, on the user interface widget, a user's selection of the symbol as a confirmation to pair the UWB device with the local wireless network.

7. The method of claim 6, wherein pairing the UWB device with the local wireless network comprises:
transmitting device information to a network control device of the local wireless network, the network control device comprising one or more of a hub, a router, a modem, a television, a set-top box, a smart speaker, a mobile device, or a range extender of the local wireless network.

8. The method of claim 4, wherein the OOB channel is a Bluetooth channel, and the device ID is a Bluetooth ID.

9. The method of claim 5, wherein computing the position information of the UWB device comprises computing a distance to the UWB device and an angle-of-arrival of the UWB device.

10. The method of claim 7, wherein:
the local wireless network is a wireless area network established based on network standards of one or more of Matter, Zigbee, Bluetooth, WiFi, IrDA, Thread, or a combination thereof; and
the network control device is communicatively coupled to the Internet.

11. The method of claim 1, wherein the obtaining of the device information of the UWB device comprises:
receiving the device information through Bluetooth communication from the UWB device, near field communication (NFC) from the UWB device, UWB data communication from the UWB device, or scanning of a QR code of the UWB device; and
storing the device information in a device database.

12. The method of claim 2, further comprising:
gathering coordinates of the perimeter to generate a virtual map of the perimeter;
computing coordinates of the UWB device based on the coordinates of the perimeter and the position information of the UWB device; and
displaying, on the user interface widget, the virtual map and the UWB device based on the coordinates of the virtual map and the UWB device, wherein
the displaying of the AR indicator comprises displaying the symbol overlaying with the UWB device in a sub-perimeter of the perimeter in the virtual map.

13. The method of claim 12, further comprising:
receiving coordinates of a second UWB device from the second UWB device; and
determining if the UWB device and the second UWB device are in a same logical group based on the coordinates of the UWB device and the second UWB device.

14. The method of claim 13, further comprising:
in response to the second UWB device being in the sub-perimeter, displaying, on the user interface widget, a notification message prompting a user to select the second UWB device to be paired to the UWB device such that the UWB device and the second UWB device are in the same logical group; and
in response to the second UWB device being beyond the sub-perimeter, displaying, on the user interface widget, a notification message prompting a user to select the second UWB device to be paired with a third UWB device in another sub-perimeter corresponding to the coordinates of the second UWB device.

15. The method of claim 12, wherein generating the virtual map of the perimeter comprises one of employing artificial intelligent (AI) to generate the virtual map or utilizing the coordinates of the perimeter stored in a memory communicatively coupled to the user interface widget.

16. A method for pairing an ultra-wideband (UWB) device in a local wireless network, comprising:
discovering a UWB device within a perimeter of the local wireless network;
determining a relative position to the UWB device via UWB ranging;
receiving coordinates of the UWB device from the UWB device;
computing coordinates based on the coordinates of the UWB device and the relative position to the UWB device; and
transmitting the coordinates.

17. The method of claim 16, wherein:
the determining of the relative position to the UWB device comprises performing a UWB ranging operation with the UWB device to obtain a distance to the UWB device and an angle-of-arrival of the UWB device.

18. The method of claim 16, wherein the computing of the coordinate comprises using at least one of two-way ranging, trilateration, triangulation, or multilateration on the coordinates of the UWB device and the relative position to the UWB device.

19. An ultra-wideband (UWB) device, comprising:
a transceiver operable to perform a UWB communication;
a memory for storing program instructions, device information, angle-of-arrivals and distances from the ranging operations; and
a processor coupled to the transceiver and to the memory, wherein the processor is operable to execute the program instructions, which, when executed by the processor, cause the UWB device to perform the following to pair another UWB device in a wireless local network:
obtaining device information of the other UWB device;
discovering, using the device information, the other UWB device within a perimeter of the local wireless network;
performing a UWB ranging operation with the other UWB device to obtain position information of the UWB device; and
displaying, on a user interface widget, an augmented reality (AR) indicator showing a location of the other UWB device based on the position information of the UWB device.

20. The UWB device of claim 19, wherein the operations further comprise displaying, on the user interface widget, the other UWB device, wherein:
the other UWB device is located in a field of view (FOV) of an imaging device communicatively coupled to the user interface widget; and
the displaying of the AR indicator comprises displaying a symbol overlaying with the other UWB device.
